(19) United States
(12) Patent Application Publication
(10) Pub. No.: US 2008/0075043 A1
(43) Pub. Date: Mar. 27, 2008

(54) METHOD AND APPARATUS FOR DYNAMIC UPDATES OF RANDOM ACCESS PARAMETERS

(75) Inventors: Jin Wang, Central Islip, NY (US); Arty Chandra, Manhasset Hills, NY (US); Mohammed Sammour, Montreal (CA); Stephen E. Terry, Northport, NY (US); John S. Chen, Ann Arbor Twp., MI (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 11/855,212

(22) Filed: Sep. 14, 2007

Related U.S. Application Data
(60) Provisional application No. 60/825,759, filed on Sep. 15, 2006.

(51) Int. Cl. H04Q 7/00

(52) U.S. Cl. 370/330

(57) ABSTRACT

A method for dynamically updating a random access channel (RACH) configuration is disclosed. One or more RACH configurations, including one or more RACH configuration parameters, in a wireless channel are detected, and the appropriate RACH configuration parameters to use based on a RACH signal.

CROSS REFERENCE TO RELATED APPLICATION

This application claims the benefit of U.S. provisional Application No. 60/825,759, filed on Sep. 15, 2006, which is incorporated by reference as if fully set forth herein.

### FIELD OF INVENTION

The present invention relates to wireless communication systems, More particularly, signaling and procedural methods that enable a wireless communication system to dynamically update the random access parameters in response to varying loads in a long term evolution (LTE) of 3G cellular networks (for UMTS beyond 3GPP Release 7) is disclosed.

### BACKGROUND

Current WCDMA UMTS systems contains mechanisms that would allow, in principle, for an adaptation of random access parameters to changing conditions. However, the need to dynamically adapt the random access channel to varying loads is less of an issue in a CDMA-based system.

Long term evolution (LTE), also termed “evolved UTRA” (E-UTRA), in contrast, uses single carrier frequency division multiple access (SC-FDMA) in the uplink, wherein the signal in the frequency domain is generated by a technique known as Discrete Fourier Transform (DFT) spread orthogonal frequency division multiplexing (OFDM), illustrated in FIG. 1. The salient aspect of this technique is that the resource units are OFDM subcarriers, so that unused resources leave “holes” in the time-frequency spectrum space. This is in contrast to CDMA, in which the overall noise level of the spectrum chunk is reduced when a physical channel does not transmit. Therefore, dynamically sizing the random access resources based on load will have a larger benefit to spectral efficiency and cell data capacity in LTE relative to WCDMA.

The current 3GPP Random Access Channel (RACH) configurations are broadcast as part of the System Information Blocks (SIBs). Specifically, a physical RACH (PRACH) system information list sent to a Wireless Transmit/Receive Unit (WTRU) is part of SIB types 5 and 6. The PRACH information element (IE) allows overall control of RACH resources by indicating, cell-wide, the available signatures, spreading factors and subchannels. The PRACH partitioning IE partitions RACH resources in up to 8 Access Service Classes (ASCs) so that each class has a contiguous set of signatures in the enumeration defined in the standard and a subset of access slot subchannels. Also, the p-persistence level of each ASC can be independently set.

One of the issues with the current RACH configuration framework in 3GPP is that it does not easily lend itself to dynamically changing RACH configurations. For example, there might be a transition period when different WTRUs read the SIBs at different times, and hence they will potentially conflict in behavior as some WTRUs are still using the old configuration and others are using the new configuration.

Therefore, there exists a need for a method, system and apparatus for dynamically changing RACH.

### SUMMARY

A method for dynamically updating a random access channel (RACH) configuration is disclosed. One or more RACH configurations, including one or more RACH configuration parameters, in a wireless channel are detected, and the appropriate RACH configuration parameters to use based on a RACH type signal.

### BRIEF DESCRIPTION OF THE DRAWINGS

FIG. 1 is a block diagram of a transmitter structure of SC-FDMA.

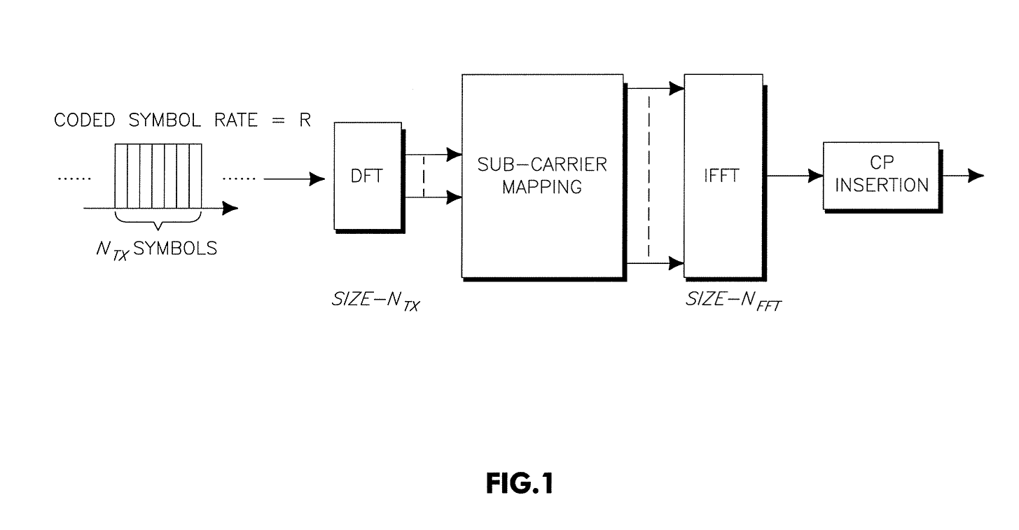

FIG. 2 is a wireless communication network having a plurality of NodeBs and WTRUs.

### DETAILED DESCRIPTION OF THE PREFERRED EMBODIMENTS

Although the features and elements are disclosed in the embodiments in particular combinations, each feature or element can be used alone (without the other features and elements of the embodiments) or in various combinations with or without other features and elements of the embodiments.

Hereafter, a wireless transmit/receive unit (WTRU) includes but is not limited to a user equipment (UE), mobile station, fixed or mobile subscriber unit, pager, or any other type of device capable of operating in a wireless environment. When referred to hereafter, a base station includes but is not limited to a Node-B (NB), evolved Node-B (eNB), site controller, access point or any other type of interfacing device in a wireless environment.

In LTE, there will likely be the capability of partitioning and configuring random access resources. Described herein are methods to support such capabilities that enhance the dynamism and flexibility of these capabilities. In one embodiment, RACH configurations are sent explicitly. These configurations may have activation and deactivation times associated with them to coordinate cell-wide behavior among all WTRUs. In an alternate embodiment, some, or possibly all, of the RACH configuration parameters are associated with a load indicator. Thus, a WTRU will have multiple sets of RACH configuration parameters to use that are selected based on the load indicator, which is broadcast by the eNB.

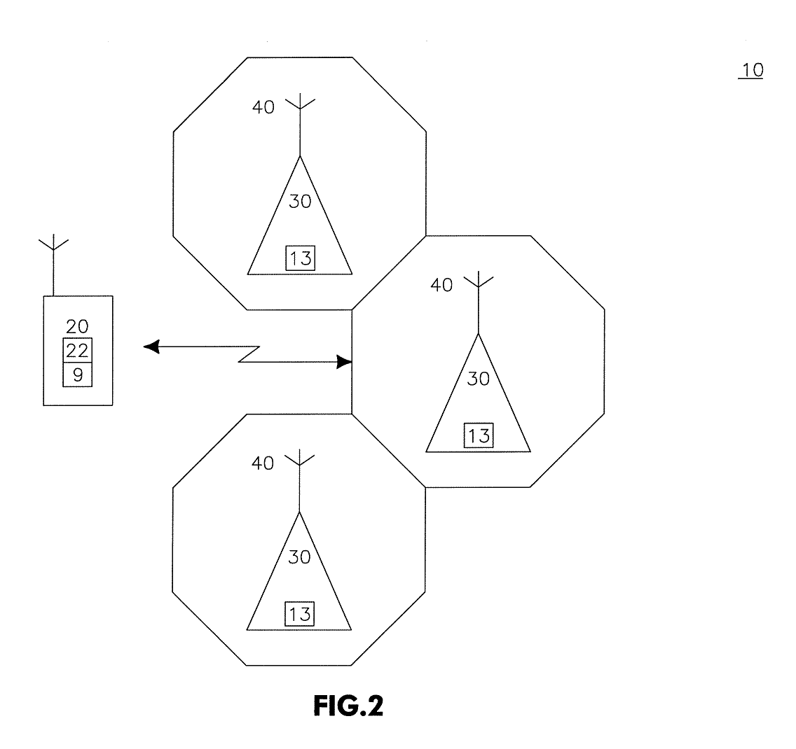

Referring to FIG. 2, a LTE wireless communication network (NW) 10 comprises a WTRU 20, one or more Node Bs 30, and one or more cells 40. Each cell 40 comprises one or more Node Bs (NB or eNB) 30 including a transceiver 13. WTRU 20 comprises a transceiver 22 and a processor 9 for implementing the method disclosed hereafter, for dynamically changing RACH configurations.

A method, therefore, is disclosed wherein a RACH indicator signal is used by a WTRU processor 9 to determine the appropriate RACH configuration to use for communication with NB 30. The RACH indicator signal allows the RACH configuration used by a WTRU 20 to change dynamically. WTRU 20, through transceiver 22, listens to a downlink broadcast signal transmitted by NB 30. Information within the broadcast signal is received and extracted by transceiver 22, which includes a RACH configuration signal and a RACH indicator signal. As those having skill in the art know, the RACH configuration signal includes RACH configuration parameters to be used by WTRU 20 to communicate with NB 30. The RACH configuration parameters may include, but is not limited to, one or more of the following:
a. Time-division multiplexed access slots;
b. Frequency-division multiplexed access resources, such as one or a set of sub-carriers;
c. Persistence factor;
d. Backoff timers; and
e. ASC or other such class differentiators of users.

Transceiver 22, upon extracting the RACH configuration signal and the RACH indicator signal, forwards to processor 9 the RACH indicator signal for selection of the RACH configuration. Processor 9, based on at least the RACH indicator signal, determines the RACH configuration that is to be used by WTRU 20 when communicating with NB 30. Depending on the wireless system, the RACH indicator signal may be associated with one or all of the RACH configuration parameters within a RACH configuration. For example, the RACH indicator signal may prompt processor 9 to select only a certain parameter of a RACH configuration.

In accordance with the disclosed method, the RACH indicator signal can be any type of signal within the downlink channel that is used by the WTRU 20 to determine the appropriate RACH configuration. The RACH indicator signal may, as an example, include one or more of the following types of indicators, an activation time, a deactivation time, an Access Service Class (ASC), or a load indicator.

As such, in a first embodiment, the RACH indicator signal includes an activation time field. The activation time field indicates to WTRU 20, through the processor 9, the time in which WTRU 20 is to begin use of the received RACH configuration or set of RACH configurations. Although the activation time field has been disclosed as being included in a signal separate from the configuration signal, in an alternative embodiment, the activation time field may be included in the RACH configuration signal. The activation time field may be in units of system frame number (SFN) or such other cell-wide reference time.

Again, the activation time field may be related to the use of one or more of the RACH configuration parameters, and therefore, may indicate to the processor 9 when to begin using one or more of the RACH configuration parameters. In accordance with this embodiment, WTRU 20 receives the RACH configuration signal from NB 30 and the RACH indicator signal including the activation time field. If the activation time field is associated with only certain RACH configuration parameters, processor 9 selects those parameters when the activation time begins. Those parameters that are not associated with the activation time are preferably left unchanged, thereby allowing WTRU 20 to dynamically adjust its RACH configuration without changing all of the RACH configuration parameters.

In an alternative embodiment, a deactivation time field may also be included in the RACH indicator signal received by WTRU 20 for indicating the time in which to stop using the received RACH configurations or set of RACH configurations. The deactivation time field would be useful, for example, in emergency situations, where a NB's top priority is to free up resources first, and then allow users to get back on to the network after it assesses the capacity constraints imposed by the situation.

It is preferable that the RACH type indicator be broadcast in the downlink channel (e.g., in the broadcast channel) until it is either deactivated by a predetermined deactivation time or superseded by the activation via a new activation time of a new RACH configuration.

Once WTRU 20 obtains the RACH configuration information, including (as applicable) the signature, a time slot and a frequency band and the activation time has occurred, normal time synchronization with NB 30 is conducted. WTRU 20 sends a burst over the selected frequency band and time slot, and monitors a specified downlink channel for response from the NB 30. Upon receipt of a response from the NB 30, WTRU 20 adjusts its timing. If a deactivation time field is received by WTRU 20, RACH configuration information in the RACH configuration signal is deactivated.

Preferably, both the activation and deactivation time are set prior to the activation time of a given RACH configuration.

In an alternate embodiment, the RACH configuration information is transmitted by NB 30 to WTRU 20 other than in the broadcast channel and the SIBs included therein. WTRU 20 receives the RACH configuration signal on a paging channel. In another alternative embodiment, the RACH configuration signal is transmitted on a control channel, either shared or dedicated, to WTRU 20. This may be desirable to get the RACH reconfiguration to certain users quickly (e.g., if the users currently are actively exchanging data with the NB 30), or a mechanism for customizing RACH configurations to particular users without impacting broadcast channel overhead.

The RACH configuration parameters to be used by WTRU 20 may be dependent on the Access Service Class (ASC) or other such class-based differentiation of users. Thus, a method is disclosed wherein an ASC or group of ASCs has a set of RACH configuration parameters that are different from other ASCs. As a result, WTRU 20 uses the RACH configuration parameters broadcast based on the ASC of WTRU 20.

NB 30 broadcasts the RACH configuration signal, including RACH configuration parameters associated with one or more ASCs, over a downlink channel monitored by one or more WTRUs 20. Depending upon the ASC assigned to the particular WTRU 20, WTRU 20 uses the RACH configuration parameters from the RACH configuration signal associated with its ASC.

In an alternative embodiment, the RACH indicator signal may further include an activation time field and/or a deactivation time field associated with the ASC. An ASC or group of ASCs may, alternatively, have activation/deactivation times that are independent from each other.

In another alternative embodiment, the RACH configuration parameter may include an activation time field and/or a deactivation time field associated with it, whereby WTRU 20 begins use of the RACH configuration parameters associated with its ASC at the activation time, and ceases use of the appropriate RACH configuration parameters at the deactivation time.

In yet another alternative embodiment, the RACH indicator signal may include a load indicator, preferably sent via the broadcast channel, that is used to determine a subset (or all) of the RACH configuration parameters to be used by a WTRU 20. It is preferable that the load indicator is nominally a scalar metric comprising measures of the load at NB 30 (e.g., traffic volume, number of active users, inter or intra-cell interference, percent utilization of resources, etc . . . ).

In accordance with this alternative, WTRU 20 listens to the broadcast channel for the RACH indicator signal, including the load indicator. Using a previously received load indicator, WTRU 20 determines its RACH parameters prior to attempting a random access on the RACH. As such, the load indicator is preferably sent prior to the RACH information signal in order to allow WTRU 20 to select the appropriate RACH configuration parameters.

A deactivation time, associated with the load indicator, may be included in the RACH indicator signal as well, for indicating the deactivation time for using the RACH configuration parameters associated with the load indicator. Similarly, an activation time associated with the load indicator may be broadcasted.

The load indicator may be mapped to a subset (or all) of the RACH configuration parameters. The mappings from a load indicator to the RACH configuration parameters are preferably sent during radio bearer establishment. It should be noted, though, that this would not be sufficient for the RACH configuration used for initiating radio bearer establishment. Alternatively, the mappings may be broadcast through SIBs in the broadcast channel, included with the RACH configuration parameters, or conveyed through control signaling or through the paging channel.

In yet another alternative embodiment, a method is disclosed in which the load indicator mappings are predefined, and therefore, NB 30 broadcasts the RACH configuration information associated with the load being encountered. As an alternative, the load experienced by NB 30 can be broadcast to WTRU 20, which selects the RACH configuration using the predefined mapping already known to it.

The load indicators may also be applied to a subset of ASCs or other such class-based differentiation of users according to an alternative method. Therefore, a method is disclosed in which the ASC to be used by WTRU 20 is based on the load indicator received by WTRU 20.

During handover, the load in a target cell can be different from the load in the serving cell. In accordance with the above, a method is disclosed that addresses the load difference during a handover. One method includes a target cell forwarding its load and RACH configuration information to a serving cell. The serving cell informs WTRU 20 about the target cell's load/configurations. Processor 9 of WTRU 20, during handover, uses the forwarded information to decide which of the RACH configurations it should use when it accesses the target cell.

Alternatively, a method is disclosed in which WTRU 20 during handover listens to a control channel in the target cell, obtains the RACH configuration and load indicator information, and decides what RACH resources to use based thereon.

In yet another alternative method, WTRU 20 during handover may access pre-defined RACH resources in the target cell (i.e. resources or configurations pre-defined to be used for the purpose of handover).

In an alternative embodiment, WTRU 20 or NB 30 may use the load and configuration information as a factor in deciding the target cell, among a plurality of potential target cells, for which it is going to communicate.

In yet another embodiment, a method is disclosed in which the determination by processor 9 of the appropriate RACH configuration to be used is based on the state of WTRU 20. As such, different RACH configuration parameters would be used by WTRU 20 depending on its state (e.g., whether it is idle or active, and whether it has a connection or not), thereby allowing the dynamic adjustment its RACH configuration as its state changes from one state to another.

The above methods may by way of example, be implemented in a WTRU or base station at the data link layer or network layer, as software, in WCDMA, TDD, FDD or LTE or HSPA based systems.

Although the features and elements of the present invention are described in the preferred embodiments in particular combinations, each feature or element can be used alone without the other features and elements of the preferred embodiments or in various combinations with or without other features and elements of the present invention. The methods or flow charts provided in the present invention may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed is:

1. A method for dynamically updating a random access channel (RACH) configuration comprising:
detecting at least one RACH configuration, including at least one RACH configuration parameter, in a wireless channel;
receiving a RACH indicator signal for selecting the RACH configuration to use; and
using said selected RACH configuration based on said RACH indicator signal.

2. The method of claim 1, wherein said RACH indicator signal includes an activation time field for indicating a time in which use of the determined RACH configuration parameters is to begin.

3. The method of claim 2, wherein said RACH indicator signal includes a deactivation time field to indicate the time in which use of the determined RACH configuration parameters should cease.

4. The method of claim 2, wherein the activation time pertains to some or all of the RACH configuration parameters including one or more of the following: time-division multiplexed access slots, frequency-division multiplexed access resources, such as one or a set of sub-carriers, persistence factors, backoff timers, access service class (ASC) and other such class differentiators of users.

5. The method of claim 1, wherein said RACH indicator signal is an Access Service Class (ASC).

6. The method of claim 5, wherein said RACH configuration parameters are associated with one or more ASCs.

7. The method of claim 6, wherein said RACH indicator signal further includes an activation time for indicating when said ASC is to be used.

8. The method of claim 1, wherein said RACH indicator signal includes a load indicator, comprising measures of the load, for determining said RACH configuration parameters to be used.

9. The method of claim 8, wherein said RACH indicator signal further includes
an activation time for indicating a time to use said load indicator; and
a deactivation time for indicating a time to cease using said load indicator.

10. The method of claim 8, wherein said load indicator is mapped to one or more of said RACH configuration parameters.

11. A wireless transmit receive unit (WTRU) for dynamically updating a random access channel (RACH) configuration comprising:
a receiver for detecting at least one RACH configuration, including at least one RACH configuration parameter, in a wireless channel; and
a processor for determining the appropriate RACH configuration parameter to use based on a RACH indicator signal.

12. The WTRU of claim 11, wherein said RACH indicator signal includes an activation time field for indicating a time in which use of the determined RACH configuration parameters is to begin.

13. The WTRU of claim 12, wherein said RACH indicator signal includes a deactivation time field to indicate the time in which use of the determined RACH configuration parameters should cease.

14. The WTRU of claim 12, wherein the activation time pertains to some or all of the RACH configuration parameters including one or more of the following: time-division multiplexed access slots, frequency-division multiplexed access resources, such as one or a set of sub-carriers, persistence factors, backoff timers, access service class (ASC) and other such class differentiators of users.

15. The WTRU of claim 11, wherein said RACH indicator signal is an Access Service Class (ASC).

16. The WTRU of claim 15, wherein said RACH configuration parameters are associated with one or more ASCs.

17. The WTRU of claim 16, wherein said RACH indicator signal further includes an activation time for indicating when said ASC is to be used.

18. The WTRU of claim 11, wherein said RACH indicator signal includes a load indicator, comprising measures of the load, for determining said RACH configuration parameters to be used.

19. The WTRU of claim 16, wherein said RACH indicator signal further includes:
an activation time for indicating a time to use said load indicator; and
a deactivation time for indicating a time to cease using said load indicator.

20. The method of claim 19, wherein said load indicator is mapped to one or more of said RACH configuration parameters.

21. A Node B wherein a random access channel (RACH) configuration is dynamically updated comprising:
a transmitter for transmitting at least one RACH configuration and a RACH indicator signal;
each said RACH configuration comprising at least one RACH configuration parameter; and
each said RACH indicator signal for indicating the appropriate RACH configuration to be used by a wireless transmit receive unit (WTRU).

22. The Node B of claim 21, wherein said RACH indicator signal includes an activation time field for indicating a time in which use of the determined RACH configuration parameters is to begin.

23. The Node B of claim 21, wherein said RACH indicator signal is an Access Service Class (ASC).

24. The Node B of claim 11, wherein said RACH indicator signal includes a load indicator, comprising measures of the load, for determining said RACH configuration parameters to be used.
